(19) United States
(12) Patent Application Publication
(10) Pub. No.: US 2008/0083219 A1
(43) Pub. Date: Apr. 10, 2008

(54) Fluid displacement based generator & method of using the same

(76) Inventor: Jerry Haagsman, Hudson's Hope (CA)

Correspondence Address: Richard C. Litman;Litman Law Offices, Ltd., Crystal City Station, P.O. Box 15035, Arlington, VA, 22215-0035, US

(21) Appl. No.: 11/650,988

(22) Filed: Jan. 9, 2007

Related U.S. Application Data
(60) Provisional application No. 60/757,033, filed on Jan. 9, 2006.

(51) Int. Cl. F01B 31/00; F04B 9/105; F16D 31/02

(52) U.S. Cl. 60/327; 417/437; 92/142

(57) ABSTRACT

The fluid displacement based generator generates usable mechanical energy through the compression and displacement of air, and through the movement of tanks containing these compressible fluids and water. The generator includes an air tank suspended above a water-filled reservoir, which is positioned within the ground or other support surface. The air tank is mounted on a support, which selectively lowers the air tank into the reservoir. The air tank is hollow and contains therein a water tank, partially filled with water. A float, which is formed of a buoyant material, is mounted within an air chamber, and may be lowered into water through the application of a user-applied force. The air tank, water tank and float are selectively vertically positionable and air pressure is maintained at a constant level within the air tank, such that vertical movement of the water tank can be used to drive an external mechanically-driven system.

### CROSS-REFERENCE TO RELATED APPLICATION

This application claims the benefit of U.S. Provisional Patent Application Ser. No. 60/757,033, filed Jan. 9, 2006.

### BACKGROUND OF THE INVENTION

1. Field of the Invention

The present invention relates to a fluid displacement based generator and a method of using the same. Particularly, the fluid displacement based generator is a system for generating usable mechanical energy through the compression and displacement of air, or other compressible fluids, and through the movement of tanks containing these compressible fluids and water.

2. Description of the Related Art

Fluid based generators and power converters are well known in the art, and generally include hydraulic or pneumatic systems for converting initially input mechanical energy into energy for driving an external system. Though such systems are typically sealed, fluid pressure must either be constantly regulated or varied throughout the operation of the system, thus requiring a large amount of energy input to sustain the system, which decreases the efficiency of the system in terms of net energy usage. Further, such systems typically require the fluid or fluids to be transferred from one chamber to the next, which causes great loss of energy in fluid resistance, friction and in the energy required to transfer the fluid.

Additionally, such systems are typically complex, requiring many mechanical and electromechanical linkages and connections, in addition to the hydraulic or pneumatic sub-systems. Mechanical interconnections are subject to vibration, displacement, misalignment and frictional forces, thus decreasing the overall efficiency of the system. It would be advantageous to minimize the mechanical components in such a system. Thus, a fluid displacement based generator and method of using the same solving the aforementioned problems is desired.

### SUMMARY OF THE INVENTION

The fluid displacement based generator is a system for generating usable mechanical energy through the compression and displacement of air, or other compressible fluids, and through the movement of tanks containing these compressible fluids and water. The fluid displacement based generator provides usable mechanical energy to an external system with a minimal energy loss within the generator, thus operating at an optimal efficiency level.

The generator includes an air tank suspended above a water-filled reservoir, which is preferably positioned within the ground or other support surface. The air tank is mounted on a support, which selectively lowers the air tank into the reservoir under user control. The air tank is hollow and contains therein a water tank, partially filled with water. The water tank has a vertical support secured to an upper end thereof, allowing the user to selectively vertically position the water tank with respect to both the ground level and the air tank in which it is housed.

A float, which is formed of a buoyant material, is mounted within an air chamber, and may be lowered into water through the application of a user-applied force. A rod or other member for pulling the float into the water is secured to a lower end of the float. The air tank, water tank and float are selectively vertically positionable and air pressure is maintained at a constant level within the air tank, such that vertical movement of the water tank can be used to drive an external mechanically-driven system.

These and other features of the present invention will become readily apparent upon further review of the following specification and drawings.

### BRIEF DESCRIPTION OF THE DRAWINGS

FIG. 1 is a side cross-sectional view of the fluid displacement based generator according to the present invention.

FIG. 2A is a side cross-sectional view illustrating a first step of operation of the fluid displacement based generator according to the present invention.

FIG. 2B is a side cross-sectional view illustrating a second step of operation of the fluid displacement based generator according to the present invention.

FIG. 2C is a side cross-sectional view illustrating a third step of operation of the fluid displacement based generator according to the present invention.

FIG. 2D is a side cross-sectional view illustrating a fourth step of operation of the fluid displacement based generator according to the present invention.

FIG. 2E is a side cross-sectional view illustrating a fifth step of operation of the fluid displacement based generator according to the present invention.

Similar reference characters denote corresponding features consistently throughout the attached drawings.

### DETAILED DESCRIPTION OF THE PREFERRED EMBODIMENT

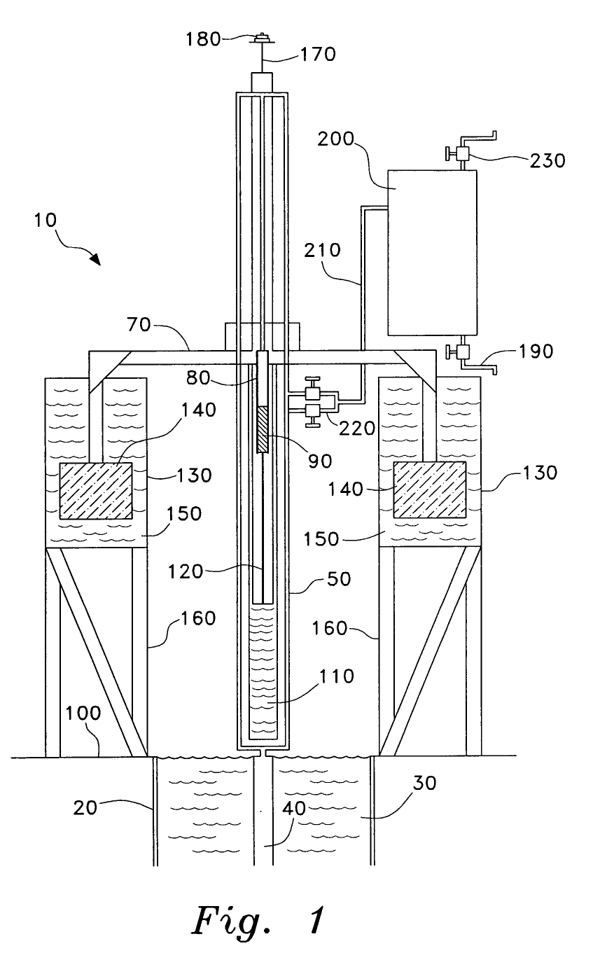

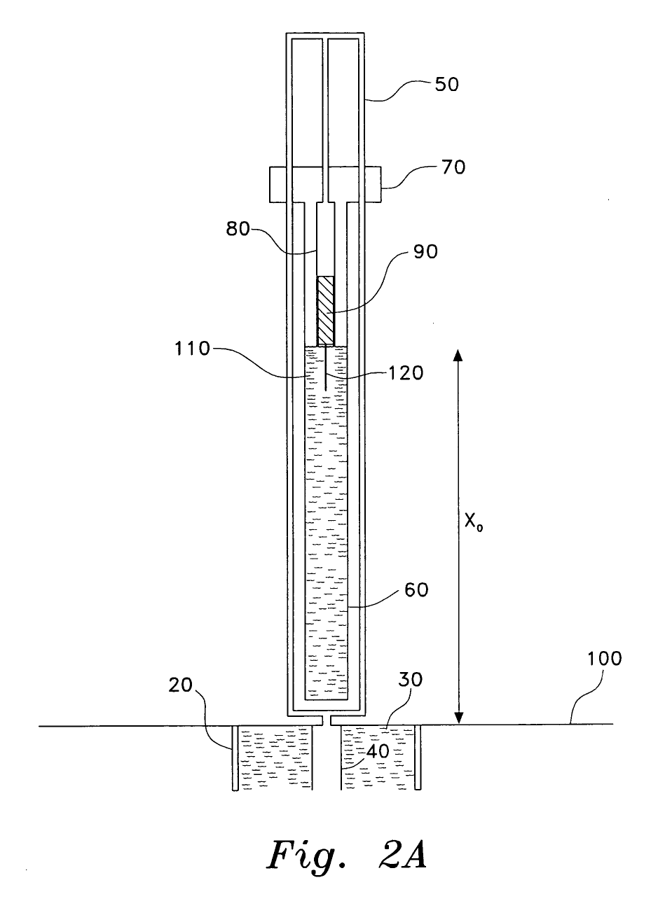

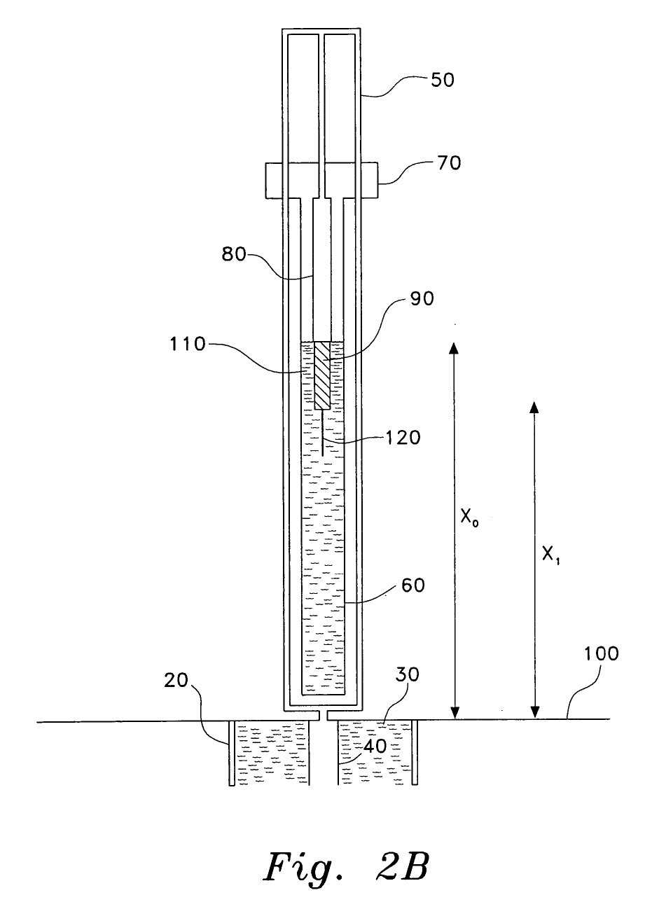

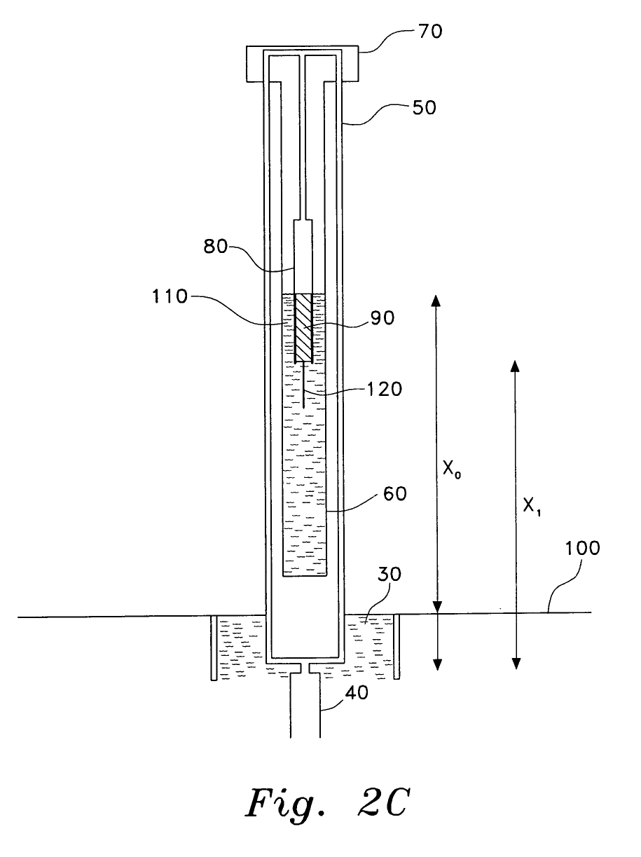

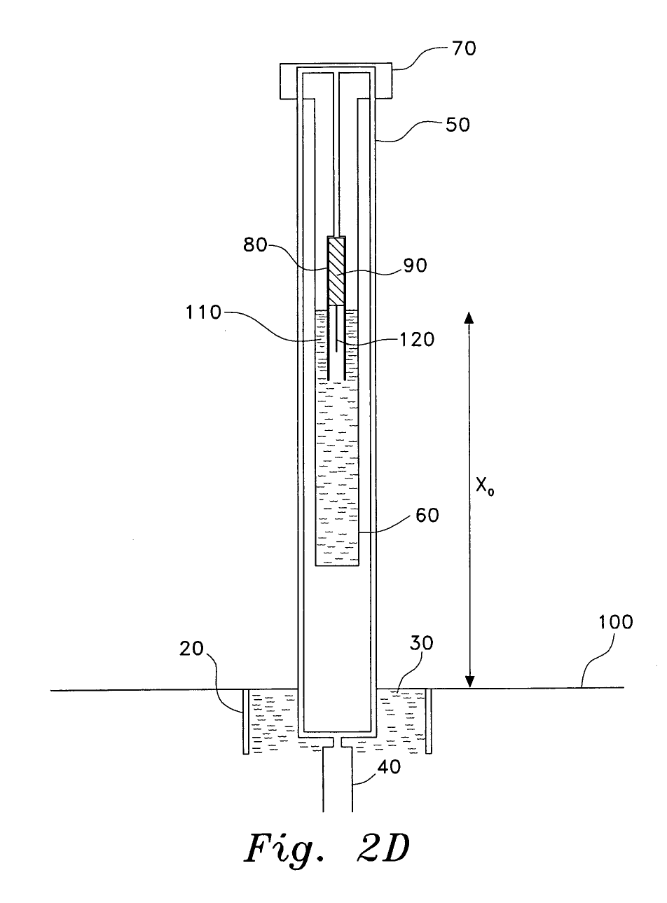

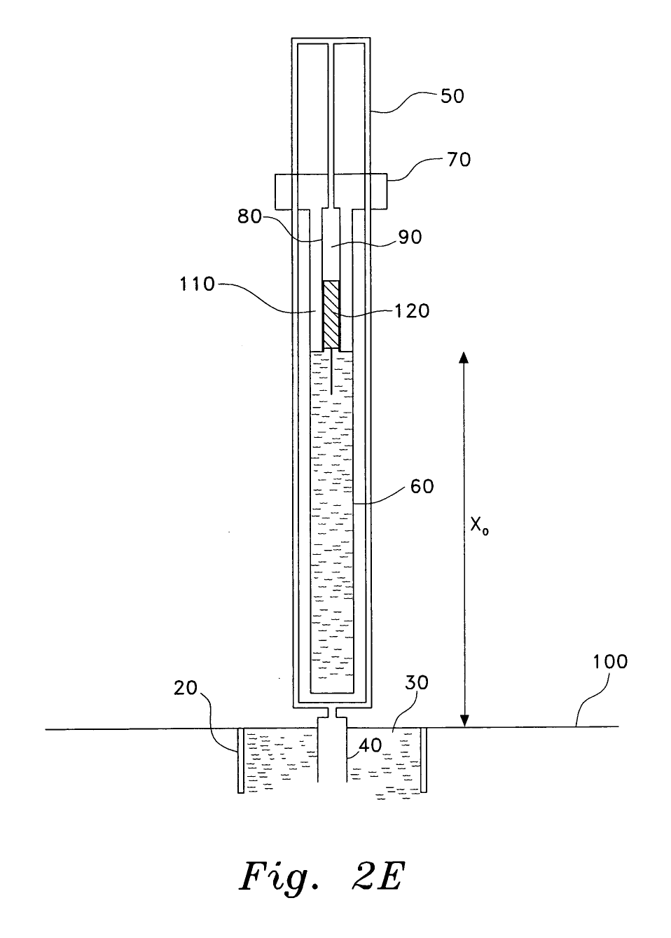

The fluid displacement based generator 10, shown in FIG. 1, is a system for generating usable mechanical energy through the compression and displacement of air or other compressible fluids, and through the movement of tanks containing these compressible fluids and water. The basic system includes an air tank 50 suspended above a water-filled reservoir 20, which is preferably positioned within the ground or other suitable support surface (best shown in FIG. 2A, with the ground level being generally designated as 100). The air tank 50 is mounted on a support 40, which selectively lowers the air tank 50 into the reservoir 20. Support 40 may be a pneumatically controlled support system or the like, and is under user control.

The air tank 50 is hollow and contains therein a water tank 60, partially filled with water 110. A float 90, which is formed of a buoyant material, is mounted within an air chamber 80, and may be lowered into water 110 through the application of an external force on rod 120. Rod 120 is secured to the lower end of float 90 and acts to pull float 90 into water 110, as will be described below. Though shown as being a rod, it should be understood that any suitable element for pulling float 90 into water 110 may be utilized, such as a rope, chain or the like.

FIGS. 2A-2E illustrate the basic operating principles of generator 10 in simplified view. In FIG. 2A, air tank 50, water tank 60 and float 90 are in their initial positions with respect to one another, and with respect to ground level 100. The initial level of water 110 within water tank 60 and the initial position of the bottom end of float 90, with respect to ground level 100, are given by x₀. Float 90 floats, initially, on top of water 110 and is held in place by the walls of air chamber 80, as shown.

In FIG. 2B, float 90 is pulled just under the water level of water 110 within water tank 60. Float 90 is pulled downwards through application of external downward force on rod 120, which is fixed to the lower end of float 90. Float 90, in this second step, now has its upper end positioned at the level of water 110; i.e., x₀, and its lower end is positioned beneath water level, at position x₁. Float 90 is no longer contained within air chamber 80, but is positioned just below air chamber 80.

If float 90 has a density substantially equal to that of the air within air tank 50, then the removal of float 90 from within air chamber 80 will create a reduction of mass of the air within air tank 50 equal to the density of the air multiplied by the volume of float 90. If a constant pressure of air within air tank 50 is maintained (as will be described below with reference to FIG. 1), then the mass of the air within air tank 50 will be increased. For example, if float 90 has a volume such that 10 pounds of air under a 50% compression ratio is displaced by float 90, then moving float 90 into water 110 causes an increase of air mass within air tank 50 of 10 pounds. Similarly, the mass of the water 110 and water tank 60 is now increased by the mass of float 90. Though the water tank 60 is contained within the air tank 50, they may be considered as two separate systems. The system including the air tank 50 has maintained a constant mass, though the mass of the air contained therein has increased. The system including the water tank 60 has now gained the mass of the float, which was initially part of the air tank system.

In the third step of operation, illustrated in FIG. 2C, the air tank 50 is lowered into water 30, contained within reservoir 20. It should be noted that the water 30 produces an upward buoyant force on air tank 50. Air tank 50 is mounted on mount 40, which is vertically driven through an external drive system, such as a pneumatic drive. At the same time, water tank 60, within air tank 50, is raised by the same distance; e.g., if air tank 50 is lowered into water 30 a distance of 1 foot, water tank 60 is raised by 1 foot, thus maintaining the water level within tank 60 at x₀. As will be described in further detail below, the upper end of water tank 60 has a mounting structure 70 formed thereon. An external vertical drive source (detailed in FIG. 1 and described below) applies a vertical driving force to mounting structure 70 in order to raise water tank 60.

The air within air tank 50 is initially pressurized at an approximately 50% compression ratio, allowing the air within air tank 50 and air chamber 80 to be compressed by the raising of water tank 60. The lowering of air tank 50 and the raising of water tank 60 by equal distances allows float 90 to maintain a constant position; i.e., the lower end of float 90 is still at a distance of x₁ with respect to ground level 100, though float 90 is, once again, housed within air chamber 80.

In FIG. 2D, float 90 is allowed to rise from water 110 back into air chamber 80, such that the lower end of float 90, once again, has a position of x₀ with respect to ground level 100. As shown in FIG. 2E, the air cylinder 50 and water cylinder 60 are vertically moved back into the initial positions of FIG. 2A, and with the regulation of air pressure within air tank 50, the mass of the air held within air tank 50 is restored to its initial mass, due to the displacement of air caused by float 90. Similarly, the mass of water tank 60 and water 110 no longer include the added mass of float 90, thus allowing for the vertical movement of air tank 50 and water tank 60, in an up-and-down manner, with no net raise or loss of mass. The vertical movement can be used to drive other mechanical systems.

As illustrated in FIG. 1, the mount 70 of water tank 60 may be a horizontal cross-beam, fixed to a pair of floats 140 at either end. Floats 140 can be driven through an external drive source for the movement of water tank 60 shown in FIG. 2C, and a generator system can be fixed to floats 140 to create driving energy for an external mechanical system.

As shown, floats 140 are housed within external tanks 130, which contain water or a similar fluid 150. Floats 140 are formed from a buoyant material, similar to float 90. Tanks 130 are supported legs or stands 160, which rest on the ground 100.

An external air tank 200 is provided. Air tank 200 contains pressurized air, allowing for the pressure regulation within air tank 50. Air tank 200 is in fluid communication with air tank 50 by feed line 210. Regulator valves 220 allow for the control and release of air flowing to and out of air tank 50. Additionally, air tank 200 includes a filler valve 230 for charging air tank 200 with pressurized air, and a drain valve 190 for releasing excess air from tank 200.

Mounted on the upper end of air tank 50 is a weight support 170, which supports weights 180. Weights 180 are removable, allowing the user to selectively govern additional downward weight acting on air tank 50. Weights 180 allow the user to compensate for non-productive and inefficient changes in the air mass within air tank 50.

It is to be understood that the present invention is not limited to the embodiment described above, but encompasses any and all embodiments within the scope of the following claims.

I claim:

1. A fluid displacement based generator, comprising:
a hollow air tank having an upper wall and a lower wall;
a water tank received within said air tank, said water tank being partially filled with water;
a container having an upper end and a lower end, said upper end being suspended from an interior surface of said upper wall of said hollow air tank, said lower end being open and being positioned above the water in said water tank;
a buoyant member removably received within said container, said buoyant member being user-selectively positioned within the water of said water tank;
means for selectively vertically positioning said air tank; and
means for selectively vertically positioning said water tank, whereby the user vertically displaces said air tank, said water tank and said buoyant member while maintaining constant air pressure within said air tank, vertical movement of said water tank being used as a driving force for mechanically driven systems.

2. The fluid displacement based generator as recited in claim 1, wherein said means for selectively vertically positioning said air tank comprises a pneumatic drive system.

3. The fluid displacement based generator as recited in claim 1, further comprising a mounting structure mounted to an upper end of said water tank, said means for selectively vertically positioning said water tank being joined to said mounting structure.

4. The fluid displacement based generator as recited in claim 3, wherein said mounting structure comprises a horizontal cross beam having opposed first and second ends.

5. The fluid displacement based generator as recited in claim 4, further comprising a pair of floatation members, each of the floatation members being secured to, and suspended from, a respective one of the first and second ends of the horizontal cross beam.

6. The fluid displacement based generator as recited in claim 5, further comprising a pair of external tanks, each of the external tanks being adapted for receiving a volume of water, each said floatation member being received within a respective one of the external tanks, each said floatation member being formed from a buoyant material.

7. The fluid displacement based generator as recited in claim 1, further comprising an external air source for selectively supplying pressurized air to said air tank.

8. The fluid displacement based generator as recited in claim 7, wherein the external air source comprises an external air container for containing the pressurized air, the external air container being in fluid communication with said air tank.

9. The fluid displacement based generator as recited in claim 8, further comprising a user-actuatable regulator valve positioned between the external air container and said air tank for selectively controlling flow of the pressurized air from the external air container to said air tank.

10. The fluid displacement based generator as recited in claim 9, further comprising a filler valve mounted on the external air container for selective connection to, and filling by, an external pressurized fluid source.

11. The fluid displacement based generator as recited in claim 10, further comprising a drain valve mounted on the external air container for selectively draining excess pressurized air from the external air container.

12. The fluid displacement based generator as recited in claim 1, further comprising at least one weighting member removably mounted to an upper end of said air tank.

13. The fluid displacement based generator as recited in claim 1, further comprising a water reservoir being received within the ground, an upper edge of the water reservoir being positioned adjacent and contiguous to ground level.

14. The fluid displacement based generator as recited in claim 13, wherein said means for selectively vertically positioning said water tank is positioned within the water reservoir.

15. The fluid displacement based generator as recited in claim 1, further comprising means for selectively positioning said buoyant member.

16. A method of using a fluid displacement based generator, comprising the steps of:
providing a hollow air tank;
providing a water tank within said hollow air tank, said water tank being partially filled with water;
providing a buoyant member within said air tank;
positioning said buoyant member above said water in said water tank;
selecting a set pressure for air filling said air tank;
pulling said buoyant member into said water;
maintaining said set pressure of said air in said air tank;
lowering said air tank by a set distance;
raising said water tank within said air tank by said set distance;
raising said float above said water; and
driving a mechanical system with the vertical movement of said water tank.
